(19) United States
(12) Patent Application Publication
(10) Pub. No.: US 2018/0189887 A1
(43) Pub. Date: Jul. 5, 2018

(54) CRYPTOGRAPHIC CURRENCY FOR FINANCIAL DATA MANAGEMENT, DIGITAL AND DIGITALIZED CROSS-ASSET IDENTIFICATION AND UNIQUE DIGITAL ASSET IDENTIFIER GENERATION, ASSET VALUATION AND FINANCIAL RISK MANAGEMENT

(71) Applicant: George Goldstein, Koenigstein im Taunus (DE)

(72) Inventor: George Goldstein, Koenigstein im Taunus (DE)

(73) Assignee: Validareum Inc., New York City, NY (US)

(21) Appl. No.: 15/859,890

(22) Filed: Jan. 2, 2018

(51) Int. Cl. G06Q 40/06; G06Q 40/08; G06Q 30/02; G06Q 20/36; H04L 9/30; H04L 9/32

(52) U.S. Cl. CPC G06Q 40/06; G06Q 40/08; G06Q 30/0201; H04L 67/104; H04L 9/30; H04L 9/3247; G06Q 20/36

(57) ABSTRACT

Present disclosure is directed to digital asset-class and digitalized cross asset-class product identification for onboarding processes in capital markets and front-to-back-office data management, valuation and risk management in financial markets and cryptocurrencies. Particular portions of the present disclosure are directed to a cryptographic currency protocol and to cryptocurrency that checks for identifiers and/or reference data, matches identifiers, reference data, price data, generates unique digital asset identifiers, valuations, risk exposures. The cryptographic-currency-protocol supports a virtual wallet that, in various embodiments, is a cross asset-class wallet for digital assets, token, cryptocurrency, smart contracts, smart legal contracts, digitalized assets, security and cash account for storing and managing the cryptographic currency and reference, price data, valuations and financial risk. Starting the asset identification, pricing, valuation and risk management process via a virtual wallet, matching with golden-copies, generating new identifiers and publishing these to nodes, cryptocurrency verified, creates an efficient data and risk management lifecycle.

### FIELD

The present disclosure relates generally to systems, apparatuses, and methods for financial data management including asset identification, reference and price data management, asset pricing and valuation, and financial risk management across all asset classes, including at least digital assets, tokenized and digitalized securities, digitalized cross-asset class financial products and their derivatives in financial markets using distributed, peer-to-peer, and cryptographic techniques.

### BACKGROUND

Reference data in the finance industry describes security identifiers and counterparties used when making a trade or financial transaction. Opposed to market data the reference data is used to identify counterparties, assets and complete financial transactions and settle these. The capital markets and broader financial services industry as well as increasingly regulatory bodies have pursued a policy of standardizing reference data that define and describe financial transactions in capital markets for securities and financial derivatives in order to achieve higher transparency and standardization.

At a basic level, reference data for a simple sale of e.g. equity/common stock in exchange for cash on e.g. a liquid stock exchange that involves a standard code/identifier for the underlying security (e.g., its ISIN), the identity of the seller, the buyer, the broker-dealer(s), etc. At its most complex level, reference data covers relevant particulars for highly complex identifications with multiple dependencies, entities, and contingencies.

Within financial services firms, pre-trade onboarding, trading and post-trade processing of digital assets (digital asset class products) or digitalized securities or cross-asset class derivatives involves a process whereby digital assets (e.g. cryptocurrency, ICOs, tokens etc.) or securities or interests in securities (e.g. debt, equity, or financial derivative contracts) require to be “onboarded” (or setup within the Financial services institution) in data management systems, risk management systems, trading systems and back office processing systems. Numerous risks arise for the parties during the financial asset/product or digital asset onboarding, pre-trade clearance, trading, and post-trade processing processes and interval. For example, a new digital asset setup, in order to be cleared for trading, into a trading system or risk management system or back office processing system or financial enterprise data management system requires for a new asset to be setup inhouse correctly prior to be traded and processed. For most securities this process is standardized based on available reference data from financial data vendors respectively the national numbering agencies providing securities identifiers, e.g. ISIN reference data or identifier for a security. Even with a relatively mature and standardized identification process for securities, additional steps need to be taken by financial institutions, which are data management tasks, risk control checks, 4-eye principle checks to secure that all systems are using the identical internal securities golden copy or mastered data inhouse. The securities reference data master or “golden copy” is being reached by applying data management mastering and matching, where multiple sources are available or desired by business units for the same data set, in order to create a golden copy for further distribution to reference data consuming systems inhouse. The vast majority of digital asset class products, as of the day of the patent application, do not qualify as securities, therefore don't request nor receive security identifiers by national numbering agencies. This leads to the new digital asset class bearing increased operational risks for onboarding and the front-to-back office processing of financial services institutions. Further, digital asset class products are primarily traded outside of the current trading system infrastructure via mainly digital wallets. This further creates the need to reconcile data between digital asset class supporting technologies, methods, processes and systems and non-digital legacy trading, risk management and post-trade processing technologies, systems, methods and increases further operational risk for financial services institutions.

Price data management is from the process and method similar to reference data management, with the key differences that price data is provided, generated or matched for already identified financial products or digital assets, digitalized assets and that price data changes (in value/price) over time, whereas reference data (e.g. an asset identifier code) changes normally only based on specific events, as e.g. in case of certain corporate actions, if at all. Those of ordinary skill in the relevant art will appreciate that there can be many data fields and data sets, multiple vendor sources as well as simple to complex matching logic to cleanse financial markets price data in order to achieve golden copy level for a data set. Valuation is an extended process of pricing, where e.g. prices aren't available from the market because a product is illiquid. In finance, valuation is the process of determining the present value (PV) of an asset. Valuation is the process of determining the current worth of an asset or a company. Those of ordinary skill in the relevant art will appreciate that there are multiple approaches and techniques used to determine value.

A cryptographic currency is a digital medium of exchange that enables distributed, cryptographically-secure, confirmed transactions for goods or services. One of the initial cryptographic currencies and still key, by market capitalization as of the day of the patent application, was Bitcoin in January 2009, which is based on a peer-to-peer (P2P) network. Since then, numerous (hundreds+) cryptographic currencies have been launched or created by Bitcoin forks, including e.g. Bitcoin Cash, Ripple, Ethereum/Ether, Litecoin etc. Fundamentally, cryptocurrencies or cryptographic currencies are specifications regarding the use of currency that seek to incorporate foundations of cryptography, especially public-key cryptography, to implement a distributed respectively decentralized information economy. A digital currency, as for example a bitcoin applied in Bitcoin, is computationally generated by an issuer (“miner”) by being mined. Digital currencies can be stored in one or more virtual cryptographic wallets, (hereinafter “wallet”), based on software and/or hardware technology to store cryptographic keys and currency. Digital currencies can be purchased (for treasury backed currencies, as e,g, the U.S.D.) United States dollars online or at an exchange), sold for services or goods, traded, or exchanged for a different currency be it treasury issued “FIAT” currency or other cryptographic currency. A sender makes a payment of digital currency by broadcasting a payment message to nodes on a peer-to-peer network (in e.g. packets or other data structures). The payment message includes the quantity of cryptographic currency changing ownership and the receiver's public address, which is key-based. The wallet holds data, identification and reference data, and/or unique identification data, identifier(s) or code(s) as well as further matched or linked data, enriching the data set(s). Those of ordinary skill in the relevant art will appreciate that there can be many data fields and data sets, multiple vendor sources as well as simple to complex matching logic to cleanse financial markets reference data in order to achieve golden copy level for a data set.

Financial risk management is the practice of economic value in a firm by using financial instruments to manage the exposure to financial risks: including the key risks: credit/counterparty risk, market risk and liquidity risk. Financial risk management requires identifying its sources, measuring it, and plans to address them. Financial risk management can be qualitative and quantitative. Key focus is on when and how to apply hedging by using financial instruments to manage the costly exposures to risk. Those of ordinary skill in the relevant art will appreciate that there are differences in managing risks for trades of a sellside bank or the investment portfolio positions of a buyside asset manager or the risks of an exchange or central counterparty, or a central bank, nonetheless the key objectives stay alike, in that to manage the risks of the financial services organization and its clients and mandates.

The generation, use and broader distribution of a standard identifier for each new digital product of the digital asset class increases transparency while reducing the risks associated with onboarding, trading and processing a digital asset class product, as equivalent for financial instruments e.g. securities in capital markets. Buy-side institutions as asset managers or sell-side institutions as investment banks onboard, trade and process securities in financial markets based on reference data created by geographically operating national numbering agencies (so called NNAs issuing ISINs—the International Securities Identification Number, e.g. also CUSIP Global Services in the U.S.A.), whose data is being further managed by data management systems that create golden copies for reference data sets, and thereby support onboarding of new products and successive inhouse processing (internally within the financial services institute). These securities identifiers help to standardize communication between financial market participants. By comparison the new digital asset class products as e.g. cryptographic currencies, ICOs, tokens are often outside of a clear numbering agencies regional scope or knowledge of it or technology, respectively in most cases clearly not classified as a security and therefore offered or traded in e.g. private offerings, initial coin offerings, so called ICOs or on digital product exchanges or alternative trading venues, who are creating and using own naming conventions including abbreviations that differ in between the trading venues. Further the abbreviations used by ICOs and cryptocurrency exchanges as eg. “BTC” for Bitcoin are mostly limited to 3 alphanumeric letters, which puts a mathematical limitation to the possible number of combinations that can be referenced at all with limited alphanumeric numbering digits. This leads to massive operational inefficiencies, scalability limitations and operational risks, as parties might trade, manage risk, execute post-trade processes based on their own truth and believe which product they are trading and/or processing. In general, a lack of transparency and industry standardization in modern financial markets is associated with increased operational risks for the participants. A cryptocurrency coin, as e.g. UDAIDcoin, generates a unique digital asset identifier (further “UDAID”), created by a cryptocurrency coin and published on a public and/or restricted distributed ledger to capital market participants as a reference data standard and thereby provides a strong guarantee and reference point during the whole digital asset lifecycle for all market participants. UDAIDcoin introduces system, apparatuses, method and process based on cryptocurrency and related blockchain technology as a new basis to generate and distribute reference data for the Digital Asset Class (further “DAC”), DAC underlying products and/or digitalized cross-asset class financial products. Further the cross-asset-class approach enables to generate a unique digital identifier for each digital asset as well as every single digitalized financial product across all asset classes, creating a unique digital standard identifier within a cryptocurrency. This reduces the need or simplifies the matter for every single market participant in the meaning of a financial services institution to manage their own reference data inhouse (financial services institutions internally, further “inhouse”), as all market participants can reference to a global digital standard across all asset classes and products vs. every single capital market participant managing its own reference data golden copy for the data set(s). This UDAID based reference data solution reduces inhouse reference data management requirements, related inhouse data management operational risks and multiple data vendor costs for purchasing reference data from multiple data vendors as well as data management costs for all participants, while increasing transparency for all market participants.

The UDAIDcoin generated UDAID (Unique Digital Asset Identifier) identifier consists of a minimum of 10+ alphanumeric digits versus the currently used 3 digits for digital cryptocurrency/ICO identifiers, allowing for true scalability and asset class growth, lower operational risk and unique identification for billions of potential digital assets. Once the asset(s) are identified, they can be priced or valuated through a pricing and valuation process, supported by cryptocurrency in a virtual wallet. Present disclosure, in some embodiments, outlines flows for asset identification, pricing and valuation as well as a risk management and risk analysis. The incorporation of pricing engines, valuation engines and risk engines (including market, credit and liquidity risk engines, what-if analysis engine) into the virtual wallet and incorporated in use of cryptocurrency merges functionalities and responsibilities historically spread across front-offices, middle-offices and back-offices of financial services firms into a single consolidated virtual wallet enabling a new level of functionality consolidation, data standardization, process optimization and cost efficiency for data management, pricing, valuation and financial risk management within financial services.

### BRIEF DESCRIPTION OF THE DRAWINGS

FIG. 1 is a hardware diagram representing components of a typical computer system on which the described technology operates and executes.

FIG. 2 is a diagram depicting an example environment within which the outlined technology may operate.

FIG. 3 is a diagram depicting an example Financial Data Management and Financial Risk Management Data Message.

FIG. 4 is a diagram depicting example UDAIDcoin(s), one partially populated example and one fully populated example, as in data request respectively reply.

FIG. 5 is a diagram depicting exemplification of virtual wallet and its engines.

FIG. 6 is a flow diagram implementing the Asset Identification and Reference Data aspects of the described technology.

FIG. 7 is a flow diagram implementing the Pricing And Valuation Data aspects of the described technology.

FIG. 8 is a flow diagram implementing the Financial Risk Management Data aspects of the described technology.

FIG. 9 is a communications flow diagram for the exchange of UDAIDcoin messages.

FIG. 10 is a different embodiment communications flow diagram for the exchange of UDAIDcoin messages with an obligation protocol.

### DETAILED DESCRIPTION

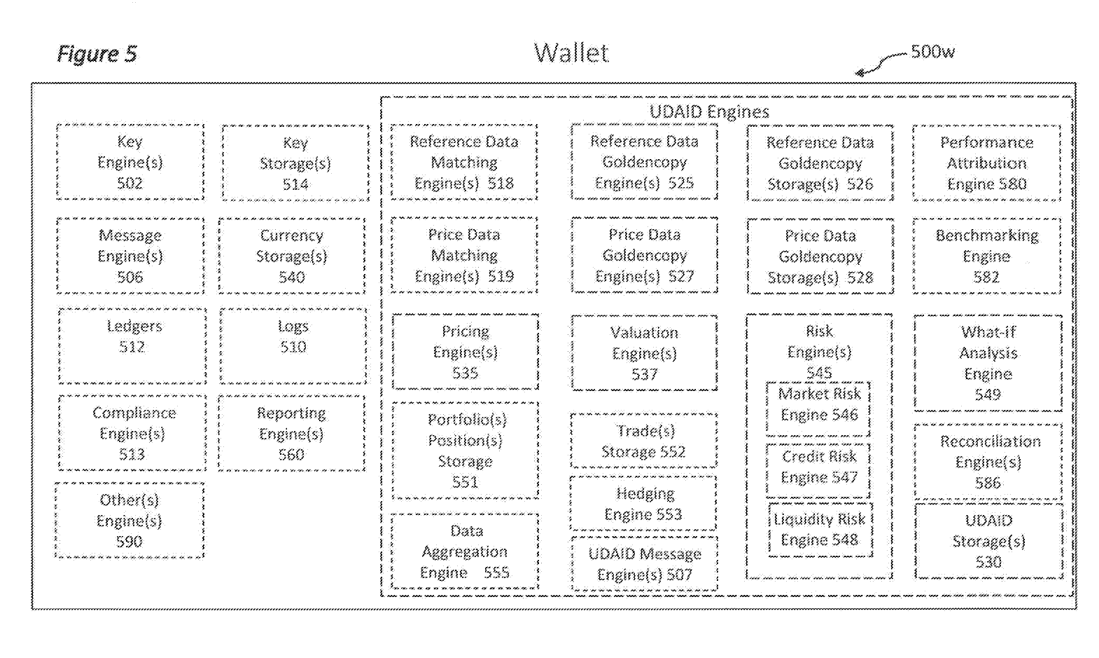

The described technology concerns one or more methods, systems, apparatuses, and mediums storing processor-executable process steps to identify digital assets and digitalized securities, digitalized cross-asset class financial products, and their financial derivatives; match reference data and/or generate unique digital asset identifiers and reference data identifiers and publish these to data manager wallet(s) and/or public or restricted ledgers, price and value assets, and manage their financial risk based on cryptographic currency technology, with lower inhouse data management and financial risk management efforts, and without the higher fault-rate and higher risks associated with siloed or systemically separated traditional financial product reference and price data management, valuation management and financial risk management, throughout the financial product lifecycle from pre-trade onboarding, trading to post-trade processing supported by Front-to-Back Office technologies and traditional data management, valuation and traditional risk management technologies in financial institutions involved in capital markets. Innovation lies not only in the consolidation of
key financial data management technologies,
key pricing and valuation technologies
key financial risk management technologies
   into one consolidated technology powered by cryptographic currency in virtual wallets, further enriched with data management engines and risk engines, among others as reference to FIG. 5, but clearly also by its
   true cross-asset class coverage of the new technology, methods, systems, apparatuses, covering both,
the new digital asset class as well as
all traditional financial products across the assets classes,
   as further outlined in detail beneath.

In various embodiments, the described technology provides a virtual wallet, that combines financial data management, pricing and valuation, and financial risk management technologies in a virtual wallet,

as traditional financial data management systems for financial securities for a Data Manager, professional investor, portfolio manager, risk controller, and as a traditional risk management technology for a risk manager, front office trader, and hedge fund manager (hereinafter ‘Data Manager’), and
as traditional valuation and pricing systems for financial securities and derivatives for a Data Manager, and
as traditional financial risk management systems for financial securities and derivatives for a Data Manager.

The wallet has technology to generate, manipulate, and store a new cryptographic currency, referred to as UDAIDcoin(s), for identifying cross-asset class assets, such as digital assets (e.g., digital coins, tokens), smart contracts or smart legal contracts, securities (e.g., stocks, bonds, etc.), cross-asset class financial derivates (e.g. CDS Credit Default Swaps, IRS Interest Rate Swaps, commodities, currencies, Future contracts or Options) and equivalents via a peer-to-peer network. In one or more embodiments, the described technology facilitates a reference data check of a requested asset(s) against the currently valid reference data master goldencopy of asset identifiers in virtual wallet(s) and/or ledger(s) on the peer-to-peer network. The reference data check can further trigger, if the match is negative, the generation of a new unique digital asset class identifier (“UDAID”) for that asset and its publishing to the respective golden copy on the ledger(s) and/or wallet(s).

In one or more embodiments, the described technology facilitates one or more price data check of a requested asset(s) against the currently valid price data master goldencopy in virtual wallet and/or ledger(s) on the peer-to-peer network. The price data check can further trigger, if the match is negative, the generation of a valuation and its publishing to the respective golden copy on the ledger(s) and/or wallet(s). In one or more embodiments, the described technology facilitates the management of financial risks of a single asset managed in the virtual wallet, all assets or a subset of these. The financial risk management tasks include the risk data requests or calculations of the risk exposures to key financial risks including market risk, credit risk, liquidity risk. Risk Management support also includes and is not limited to UDAID Engines referenced in FIG. 5, including what-if scenarios, hedging, benchmarking, etc.

As implemented by the described technology, a Data Manager no longer needs to lookup multiple data vendor sources, data services or data feeds and/or systems in order to setup a new e.g. security in the reference data management system, bearing all of the associated operational and data management risks purely inhouse. Data Managers using the described technology set up securities by presenting a reference data identification request(s) in their respective wallets. UDAIDcoin identifies, matches with the ultimate reference data master data, and if non-existent/generates a new unique digital asset identifier (hereinafter called “UDAID”). The reference data master(s) are based on network ledgers within a peer-to-peer network, guaranteeing highest data availability and data quality, data governance and faster asset identification and digital asset product setup or confirmation for further data enrichment or processing. Having successfully identified the asset(s), value added data management and financial risk management technologies are able to be executed in the same virtual wallet including, pricing and valuation and management of the financial risks among others.

Miscellaneous embodiments of the technology will now be described. The following outlined description provides specific details for a thorough understanding and enabling description of these embodiments. One skilled in the art will appreciate, that the described technology may be exercised without these details. Further some well-known functions may not be described in detail, in order to avoid unnecessarily deception of the relevant description of various embodiments. Terminology used in the description provided below is intended to be interpreted in its broadest reasonable manner, even though being used in conjunction with a detailed description of certain specific embodiments of the technology. Any terminology intended to be interpreted in any restricted manner will be overtly and specifically defined as such in this section. The technologies and techniques introduced below can be implemented by programmable circuitry programmed or configured by software and/or firmware, or entirely by special-purpose circuitry, or in a combination of these. Such special-purpose circuitry can be in the form of, e.g. one or more application-specific integrated circuits, programmable logic devices, programmable gate arrays, and so forth.

In one or more embodiments, the described technology adapts and/or generates a cryptographic wallet which holds a new cryptographic currency (i.e., an UDAIDcoin) and corresponding cryptographic protocol for exchanging Financial Data Management and Financial Risk Management Data messages between nodes on a peer-to-peer network. Instead of representing a single transferable object, an UDAIDcoin wallet holds multiple Financial Data Management and Financial Risk Management Data items (e.g., digital asset identification information as the e.g. the reference data name, country of issuance etc., price, value, associated financial risks), herein referred to as a Financial Data Management and Financial Risk Management Data inside cryptographic currency, and an Unique Digital Asset Identifier (i.e., a globally unique asset identification code or identifier represented by an UDAIDcoin wallet). An UDAID is generated and used by the peer-to-peer network to refer to a specific digital asset or cross-asset class digitalized asset. For example, “Bitcoin Cash” (the name of the cryptocurrency Bitcoin Cash) can also be an UDAID used by the peer-to-peer network to refer to Bitcoin Cash. UDAIDs can be issued or generated by the UDAID Data Management Service upon digital request message of a UDAIDcoin based wallet. The UDAID generation or format as length, data sequence, abbreviation, etc. may change over time, as required by scalability, technical, and/or legal/regulatory and/or business reason(s).

An UDAIDcoin wallet or message can house a single digital asset, e.g. cryptocoin, token, smart contract, smart legal contract, and digitalized asset, e.g. digitalized security or debt, and/or multiple digital assets and/or digitalized cross-asset class financial assets.

UDAIDcoin supports cross-asset class financial assets covering the today technically devided digital asset class as well as the “classical” asset classes as FX, MoneyMarket, Interest Rates, Commodities, Securities, Debt, Financial Derivatives etc.

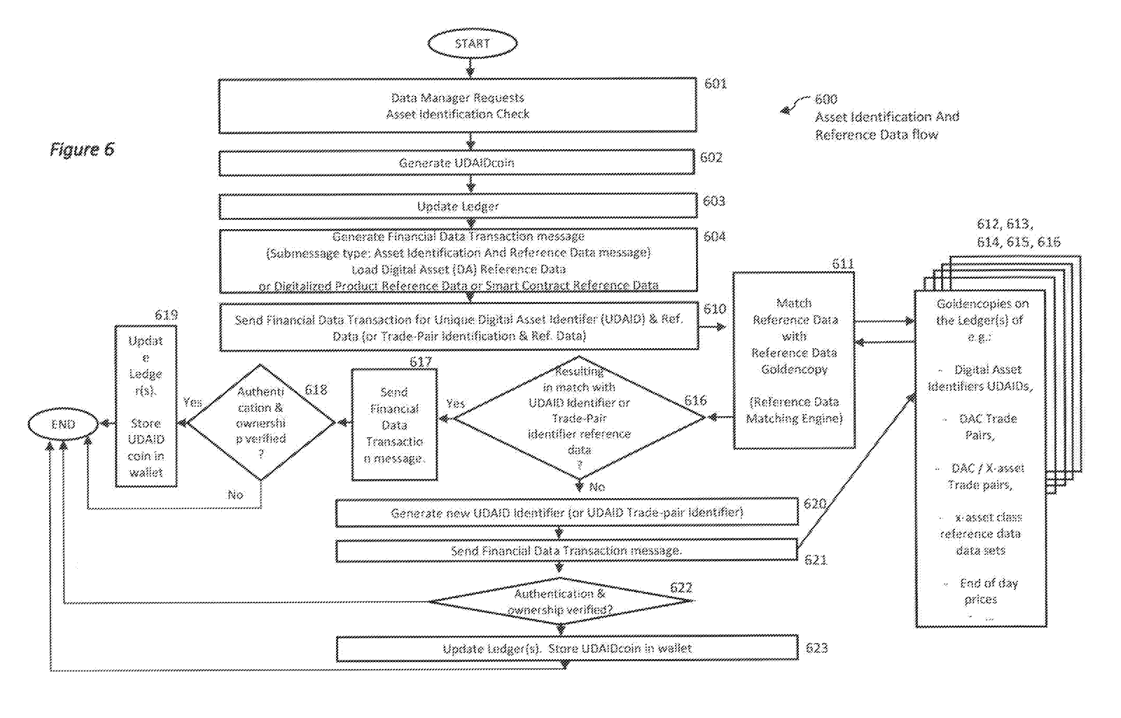

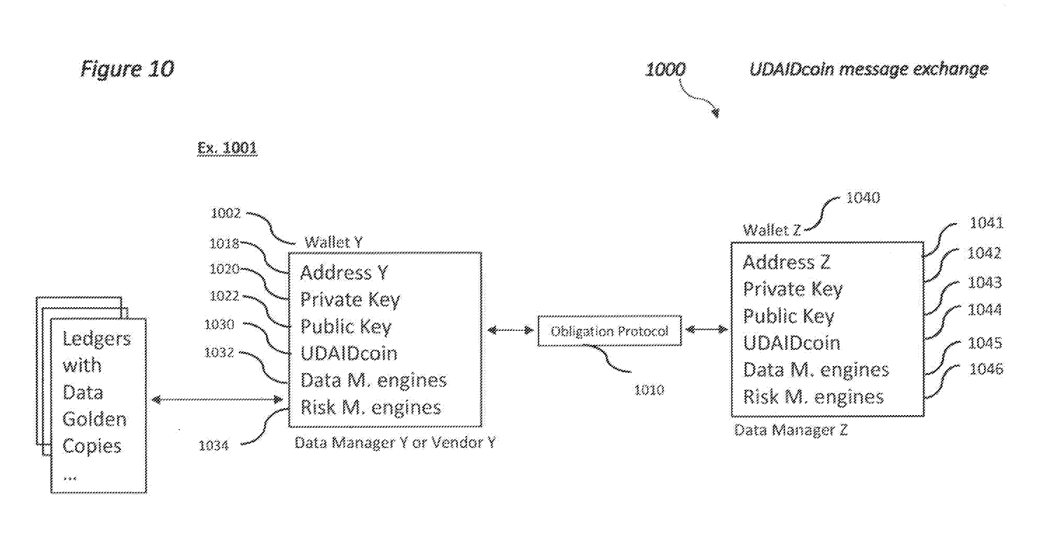

The described technology, in various embodiments, generates and/or modifies a cryptographic currency wallet for enabling a Data Manager (or Risk Manager, or Portfolio Manager or Trader, hereinafter “Data Manager”) to use a wallet as his Financial Data Management and Financial Risk Management account. The wallet is a software and/or hardware component for facilitating for example asset identification requests, reference data requests, price request, valuation request, financial risk exposure calculation, hedging calculation, securely storing UDAIDcoin(s) (via one or multiple private keys), and providing other technology such as generating and maintaining cryptographic keys, generating local and network messages, generating financial data and financial risk data requests, updating ledgers, performing currency and/or cryptocurrency conversion, and providing financial data and financial risk management data. As described above, in various embodiments, the described technology generates UDAIDcoin Financial Data Management and Financial Risk Management Data messages based on the wallet's content. For example, Data Manager X decides to request a UDAID reference data check for Bitcoin Cash to a UDAID data vendor or Data Provider Y. Data Manager X enters his financial data request into his wallet. The described technology generates the appropriate messages, which are broadcasted to the network for authentication respectively verification. The asset identification request message is sent to the network, in one or more embodiments. The described technology, in various embodiments, implements an atomic obligation protocol, (such as e.g. two-phased obligation protocol), to ensure financial data management data governance and ownership of the asset in his wallet respectively ownership of UDAIDcoin for the transaction. A coordinator of the two-phase obligation is, in some embodiments, a trusted node and/or coordinator. The coordinator is elected based on the network protocol, in alternative embodiments. e.g. a node can be elected as the coordinator based on random token exchange, number of validated requests sent, or other quantitative or qualitative qualifier(s). Regardless of the coordinator, after each node is committed, appropriate asset identification messages are broadcast to provide UDAIDcoin based reference data. Those of ordinary skill in the art will appreciate that further embodiments of the present disclosure can be practiced without some of the details described above or with minor changes based on the specific data set of the request and related data message. Therefore the disclosure is in general valid with minor changes for most reference data and price data sets and data requests and data messages. FIGS. 6 through 10 outline the key distinctions of data messages and communications flow based on the data set(s), data request(s) and data message(s).

UDAIDcoin ownership is transmitted via one or more Financial Data Management and Financial Risk Management Data messages. A Financial Data Management and Financial Risk Management Data message includes Financial Data Transaction and a digital signature. The financial data transaction includes, for example, the UDAIDcoin, the receiver's electronic address, and, in some embodiments, ownership history. This is a record of previous UDAIDcoin ownership, if any, and used by the network to verify proper chain of title. The addresses are based, in various embodiments, on one or multiple cryptographic protocols (e.g., public-key cryptography). Public-key cryptography requires two separate keys, of which one is secret (i.e., a private key) and one is public. The two keys are effectively different, but mathematically linked. The public key is used to encrypt plaintext (e.g., for creating an address for receiving an UDAIDcoin) and for verifying a digital signature. The private key is instead used to decrypt cipher text, to create a digital signature, and to secure UDAIDcoins. Public keys are freely shared among nodes in the peer-to-peer network, for example by broadcasting one or more key-exchange messages. The Financial Data Management and Financial Risk Management Data message, in various embodiments, is digitally signed by the sender's private key to authenticate the sender's identity to the network nodes, e.g., by decrypting the sender's digitally signed message using the sender's public key to verify origination of Financial Data Management and Financial Risk Management Data message sender.

The described technology, in various embodiments, verifies UDAIDcoin ownership, preventing fraudulent manipulation. UDAIDcoin ownership is based on ownership entries in ledgers that are maintained by distributed network nodes. UDAID reference data is based on reference data entries in ledgers that are maintained by distributed network nodes. The ledgers are mathematically linked to the owners' public-private key pairs generated by the owners' respective wallets. Ledgers record entries for each single change of ownership of each UDAIDcoin transposition in the network. A ledger is a data structure (as text, structured text, database records, etc.) that resides on all or partial network nodes. After an UDAIDcoin transaction (i.e., an indicative ownership change message) is broadcasted to the network, the nodes verify in their respective ledgers that the sender has proper chain of title, based on previously recorded ownership entries for that UDAIDcoin. Transaction verification is based on mutual consensus among the nodes. The nodes compare their respective ledgers to see if there is a break in the chain of title. A break in the chain of title is detected when there is a deviation in one ledger or more of the ledgers, suggesting possibility of a potentially fraudulent transaction, data set or message. If the nodes reach agreement on the sender being the owner of the UDAIDcoin, the nodes' ledgers are updated to indicate a new ownership execution, and the receiver becomes the UDAIDcoin's owner. Verification protocols of other cryptographic currencies, in one or more embodiments, are used with UDAIDcoins (comparable to “bitcoins”, which are validated based on “blocks” in “block chain”). Unconcerned of the specific protocol(s) used, the receiver becomes the cryptocurrency's owner after the chain of title is verified and the ledger is updated. Regardless of the specific protocol(s) used, the goldencopy ledgers are verified by the P2P network nodes. In other embodiments, a goldencopy ledger verification may be monitored and/or corrected by a Data Management Service node(s), representing a data vendor superuser or a government body in the meaning of a regulator, as e.g. the SEC.

When an UDAIDcoin is initially created (i.e., by an issuer) no previous owners exist from which to verify ownership in the ledgers. In one or more embodiments, the issuer can maintain the same private key for digitally signing each UDAIDcoin as it is issued and entered into the ledgers. In turn, that private key, can be validated by mutual agreement between the nodes, by a trusted third party or by one or multiple different associated security mechanisms.

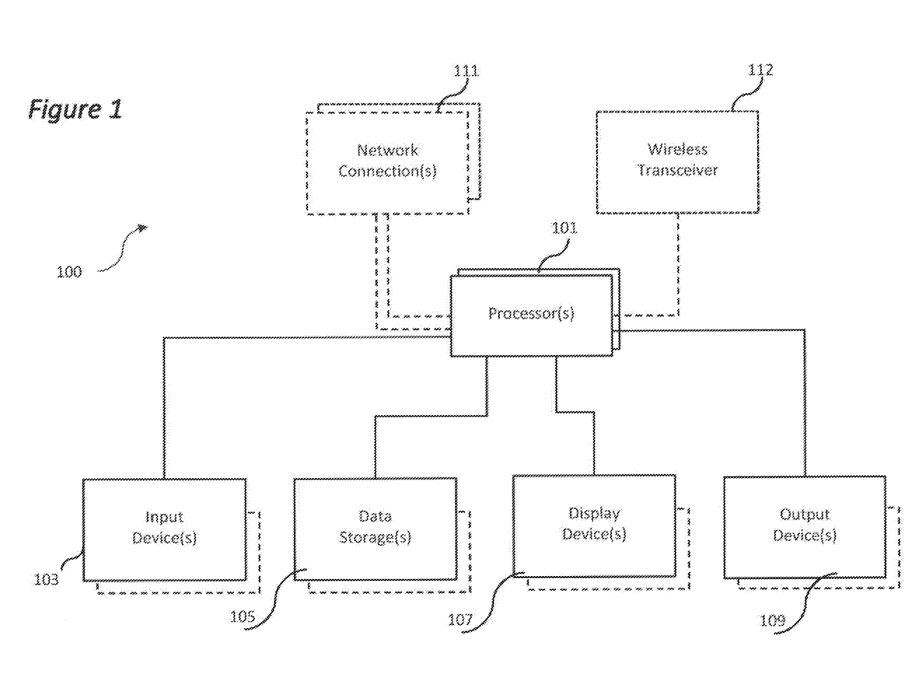

Using the described technology outlined above and described in further detail below in reference to FIGS. 1-10, financial data management and financial risk management data are provided independently, verified, and executed within the network, without the risks associated with traditional inhouse financial data management and financial risk management processes that can delay identification and onboarding or further processing even for multiple days.

Particular details are set forth in the description beneath and in FIGS. 1 through 10 to serve as a complete understanding of diverse embodiments of the present disclosure. Miscellaneous well-known structures and systems often associated with financial data management and financial risk management, cryptographic currencies, peer-to-peer (P2P) networks have not been shown or described in detail below to avoid unnecessarily obscuring the descriptions of the various embodiments of the present disclosure. A person of ordinary skill in the relevant art will understand that the present disclosure may have further embodiments that may be exercised without some of the details provided below. Those of ordinary skill in the relevant art will appreciate that the methods and systems described can include additional details without departing from the spirit and/or extent of the disclosed embodiments. Some details, ledgers and dimensions, functions, shown and outlined in line with FIGS. 1 through 10 are solely illustrative of particular embodiments of the present disclosure. Correspondingly, other embodiments can have other details and/or dimensions, functions, and features without diverging from the idea or extent of the this disclosure. Those of ordinary skill in the art will appreciate that further embodiments of the present disclosure can be practiced without some of the details outlined beneath.

FIG. 1 and the following outlined consideration provide a general definition of a computing environment and with which facets the outlined technology can be implemented. Some aspects of the technology may be described herein in general context of computer-executable instructions, such as routines executed by a general data processing device (as for example one or multiple server(s) or client computers). Facets of the technology described may be stored or distributed on computer-readable media, including magnetically and/or optically readable computer discs, hard-wired and/or preprogrammed chips, diverse technologies of memory, or other data storage media. Alternatively, server or computer-implemented instructions, data structures, monitor displays, other data related to the technology may be distributed over other networks and/or via the Internet or via wireless networks on a propagated signal. In some implementations, the data may be provided on any analog or any digital network.

The described technology can as well be run and executed in distributed ledger and distributed computing environments, where tasks or modules are performed by remote processing devices, which are linked through a network, such as a LAN (Local Area Network), WAN (Wide Area Network) or via the Internet.

In a distributed computing environment, program modules or subroutines may be located in local or remote memory storage devices or a combination thereof. Parts of the outlined technology may reside on a server, while corresponding parts may reside on a client computer (e.g., Personal Computer, mobile laptop computer, ipad or tabet, smart phone, etc.). Data structures and data transmission of particular facets of the technology are enfolded within the scope of outlined technology. Especially the financial risk management components and outlined risk engines require a high-performant scalable computing environment, which can differ from in memory computing on the chip to grid computing of the scenario analysis, exposures and hedges.

Reference to FIG. 1, the outlined technology implements a computer 100, such as a server, personal computer, workstation, phone, smart phone, iPad or tablet, or smart watch (not displayed in FIG. 1) having one or more processors 101 coupled to one or more user input devices 103, data storage devices 105. The computer 100 is also coupled to at least one output device, such as a display device 107, and one or more optional additional output devices 109 (printer, diverse output devices, etc.). The computer 100 may be coupled to external computers, such as via a network connection 111, and/or wireless transceiver 112, or both or multiple of these. E.g. network hubs, switches, routers, or different hardware network components within the network connection 111 and/or wireless transceiver 112 can couple one or more computers/desktops and/or servers 100. The input devices 103 may include a keyboard and a mouse or input pad. Other input devices are as well possible, such as a microphone, scanner, digital camera, video camera, and the like. A machine to machine input option is also possible. The data storage devices 105 may include any type of computer-readable media that can store data accessible by the computer 100, such as diverse magnetic hard and floppy disk drives, optical disk drives, flash memory cards, digital video disks, RAMs, ROMs, smart cards, etc. Any medium for storing or transmitting computer-readable instructions and data may be used, including a port connection or network node, as e.g. LAN, WAN, or the Internet (not represented in FIG. 1).

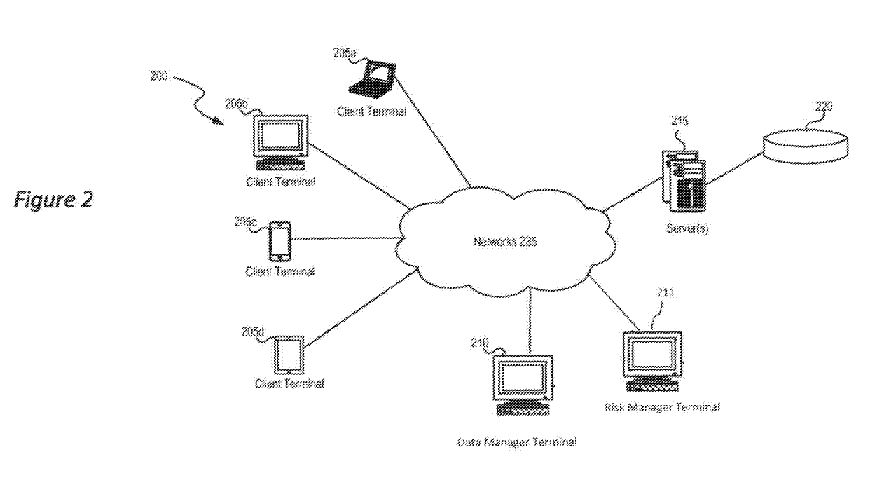

Reference to FIG. 2, the diagram is displaying a sample operational environment 200 within the outlined technology. Environment 200 may include client terminals nodes from which clients (for example via their wallets), or Data Managers are entering requests for financial data management and financial risk management data. E.g. reference data check for digital asset class product, smart contract, reference data of various digitalized cross-asset class financial products (as e.g. stocks, bonds, options, futures, commodities, structured products as e.g. warrants etc.) which are interchangeable between nodes 205-215 in the form of financial data messages and UDAIDcoins.

Non-limiting examples of client nodes include a laptop computer 205a, a desktop computer 205b, a mobile device 205c, a tablet device 205d, smart watches and glasses (not shown), servers or server farms instead of computers. Data Managers may utilize nodes 205a-205d to access an electronic financial data management and financial risk management platform. The environment 200 may also include one or more Data Manager terminals, represented by terminal 210. The Data Manager terminal 210 may be utilized by a Data Manager who is representing another end-client, e.g. a security service provider representing the end-client being an asset manager or their respective Data Manager, for example. A Risk Manager might e.g. request financial risk management data, risk exposures and UDAIDcoin via Terminal 211. The environment 200 may also include server(s) 215, which may be coupled to one or more databases and/or tables represented by database 220. Server(s) 215, in some embodiments, are dedicated or partially dedicated nodes that facilitate various aspects of the described technology (e.g., UDAIDcoin exchange, verification, two-phase obligation, etc.). Client nodes 205 a-205 d, Data Manager Terminal 210, and server(s) 215 (e.g., a financial data management server and/or exchange server) may connect to and communicate with each other across peer-to-peer network 235 using e.g. secure communications protocols such as Hypertext Transfer Protocol (HTTP), or secure HTTPS, File Transfer Protocol (FTP), Secure Socket Layer (SSL), and/or the like. Examples of network 235 may include restricted/private and/or public peer-to-peer networks e.g., as part of the Internet or a mix of these.

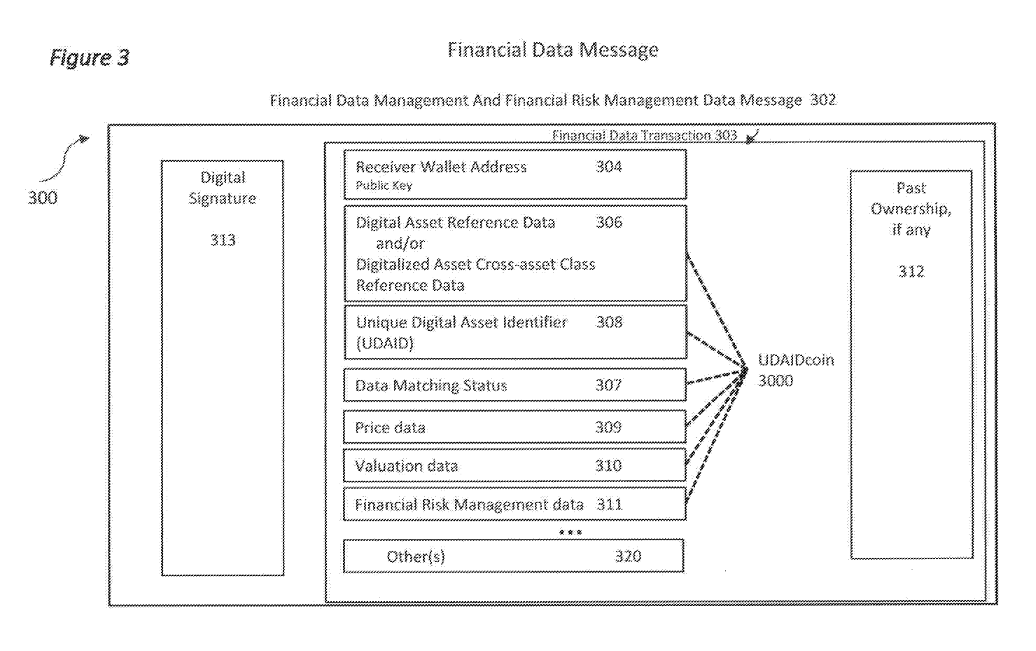

FIG. 3 is a diagram 300 depicting an example Financial Data Management and Financial Risk Management Data Message 302. Financial Data Management and Financial Risk Management Data Messages 302 are used by the described technology for changing UDAIDcoin 3000 ownership. A Financial Data Management and Financial Risk Management Data Message 302 includes a Financial Data Transaction 303 and the sender's digital signature 313 of the Financial Data Transaction 303. The Financial Data Transaction 303 includes the recipient's address 304 (a for example hash value based on the receiver's public key), the UDAIDcoin 3000 (i.e., Digital Asset Class (hereinafter “DAC”) DAC reference data 306, Data Matching Status 307, and the Unique Digital Asset Identifier—the UDAID identifier 308, Price data 309, Valuation data 310, and Financial Risk Management Data 311), past ownership information 312 (if any), and optional other information 320 (e.g., reference to goldencopy ledger etc.). The Financial Data Transaction 303 is digitally signed by the sender's private key to create a digital signature 313 for verifying the sender's identity to the network nodes 205-215. The network nodes 205-215 decrypt the digital signature 313, via the sender's previously exchanged public key, and compare the unencrypted information to the Financial Data Transaction 303. If they match, the sender's authenticity is verified and, after a proper chain of ownership is verified via the ledgers (as explained above), the receiver is recorded in the ledgers as the new UDAIDcoin 3000 owner.

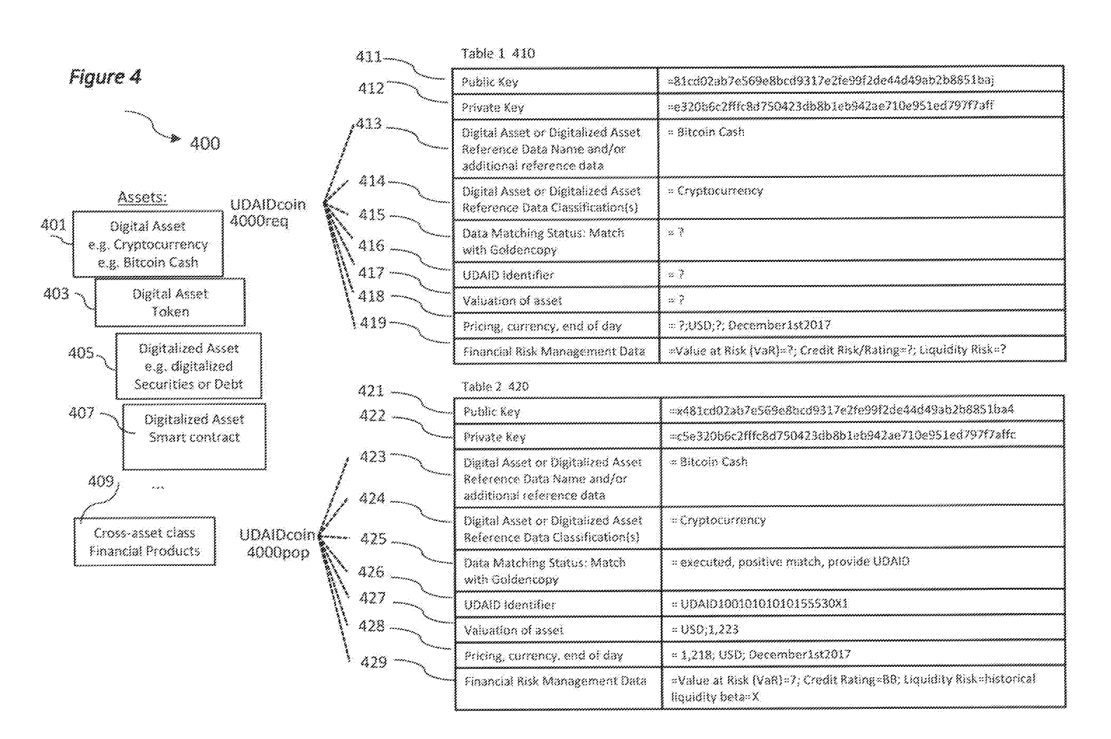

FIG. 4 is a diagram 400 depicting example UDAIDcoins 4000req with 413 through 419 and 4000pop with 423 through 429. For example, the digital asset class product “Bitcoin Cash” is a sample asset 401. Other digitalized assets, may be a token 403 or other digitalized financial products as securities or debt 405, smart contracts 404 or any other digitalized cross-asset class financial product or its derivative 409. As depicted in table 1 410, UDAIDcoin 4000req is requesting asset identification and further reference, price, valuation and financial risk m. data for the digital asset 401 and is associated with public key 411 and private key 412. In other embodiments, a UDAIDcoin 4000pop contains the populated data reply and a verified UDAID identifier. For example, as depicted in table 2 420, UDAIDcoin 4000pop is associated with public key 421 and private key 422. A Financial Data Transfer 303 can include multiple UDAIDcoins 3000 (e.g. 401n). An UDAIDcoin's denomination is based on how the UDAIDcoin 3000 is issued (e.g., by the UDAIDcoin underwriter) and, in some embodiments, how it was aggregated by the wallet 500w (as further outlined beneath).

FIG. 5 is a block diagram depicting an example virtual cross-asset class wallet 500w (hereinafter referred to as wallet 500w). The described technology provides a software and/or hardware wallet 500w for storing, sending, receiving and managing UDAIDcoins, or other cryptographic currencies, and additional information. Wallet 500w contains and/or is associated with various components 502-590 to facilitate features of the described technology; however, wallet 500w is operable with a subset of constituent parts 502-590. E.g. wallet 500w includes one or more key engine components 502, key storage components 514, UDAID storage components 530, data matching engine components 518 and 519, message engine components 506 and 507, UDAIDcoin respectively cryptocurrency and/or currency storage components 530 and 540, log components 510, reference data engine components 525, and various other components 550 that are used to implement various functions and features of the described technology. Key engine component 502 generates public-private key pairs for sending and receiving UDAIDcoins, which are stored in UDAIDcoin storage component 530. Key storage component 514 stores locally generated public-private key pairs and, in some embodiments, keys received from other wallets 500wn (e.g., a public key associated with a different Data Managers wallet 500wn). Matching engine components 518 and 519, in some embodiments, generate UDAID data checks (or modifies Financial Data Management and Financial Risk Management Data messages 302 to include UDAID code information, e.g., other information 320) for exchanging UDAIDcoins. The Financial Data Management and Financial Risk Management Data messages are, in one or more embodiments, broadcast to one or more nodes 205-215 that coordinate Financial Data Management and Financial Risk Management Data tasks. Message engine components 506 and 507 generate various messages used by the described technology for communicating between, e.g., nodes 205-215. For example, message engine component 506 can generate Financial Data Management and Financial Risk Management Data messages 302 (and submessages in some embodiments with reference to Asset Identification and Reference Data 600, Pricing and Valuation 700, Financial Risk Management 900) and exchange UDAIDcoins between two or multiple Data Manager wallets 500w. Currency storage component 540 is implemented to store different types cryptographic currencies (e.g., bitcoins), or FIAT currency cash equivalents. Wallet 500w can further generate any necessary ledger updates (e.g., transaction log component 510) and messages for sending ledger updates, for example, to the other nodes 205-215 so that goldencopy ledgers and/or ownership rights are updated for the newly generated UDAIDcoin. Transaction log components 510 are configured to store a variety of accessible data, such as local transaction information (e.g., the ledger data and other transactions made at or to the wallet 500w, for example, based on one or more of the engine components 502, 506, 510, etc.) and remote transaction information (e.g., network information, node operation information, and protocol information). Data matching engine components 518 (reference data) and 519 (price data), in some embodiments, receive and/or provide reference and price data from, for example, a Data Manager (e.g., one of the servers 215) or a separate server that is accessible to nodes 205-215 but is not necessarily a node on the peer-to-peer network. Digital asset class reference data allows Data Managers to identify and onboard products into further processing, be it front-to-back office related. In some embodiments Risk engine 545, can consist of a single or multiple risk engines with focus on specific subareas of risk, as e.g. market risk, credit risk, liquidity risk or other risks managed. Various other engines, storages, and data management techniques (e.g., incorporated into component 590) are optional extentions and, in some embodiments, can be integrated as new, component replacing and/or interchangeable components in wallet 500w.

FIG. 6 is a flow diagram 600 implementing various aspects of the described technology, such as exchanging UDAIDcoin(s) 3000 between wallet X 904 and wallet Y 902 for other UDAIDcoin 3000 or another cryptographic currencies (e.g. bitcoin) for the provided Asset Identification And Reference Data service from Data Vendor Y. A Data Manager, at step 601, triggers a new Asset Identification And Reference Data request, which is a Financial Data Transaction 303 for a particular digital asset or digitalized asset. For example, an entity, creates an Asset Identification And Reference Data check request for “Bitcoin Cash” to represent the digital cryptocurrency Bitcoin Cash, as in 401. At step 604, an UDAIDcoin generates the identification message and loads relevant reference data for the identification message 4000req. A sample data request is outlined under UDAIDcoin 4000req. At step 610, the described technology sends the reference data message to the matching engine 518, which executes the matching request in step 611 by checking for existing goldencopy records for that asset in the ledgers 612-616. Those of ordinary skill in the relevant art will appreciate that there can be multiple steps incorporated to achieve different levels of matching results incl. inclusion of confidence levels, data types and sources, quantitative and qualitative components and functionalities and features. The result is either “matched” in 611 and leads to steps 616 through 619 if the match result is positive, or if the match is negative, it results in generating a new UDAID identifier as outlined in step 620. A new UDAID is published, as outlined in step 621. It is only after positive verification and ownership check in step 622, that the new UDAID is published to the ledgers to become part of the master goldencopy on the ledger 612, 613 and onwards.

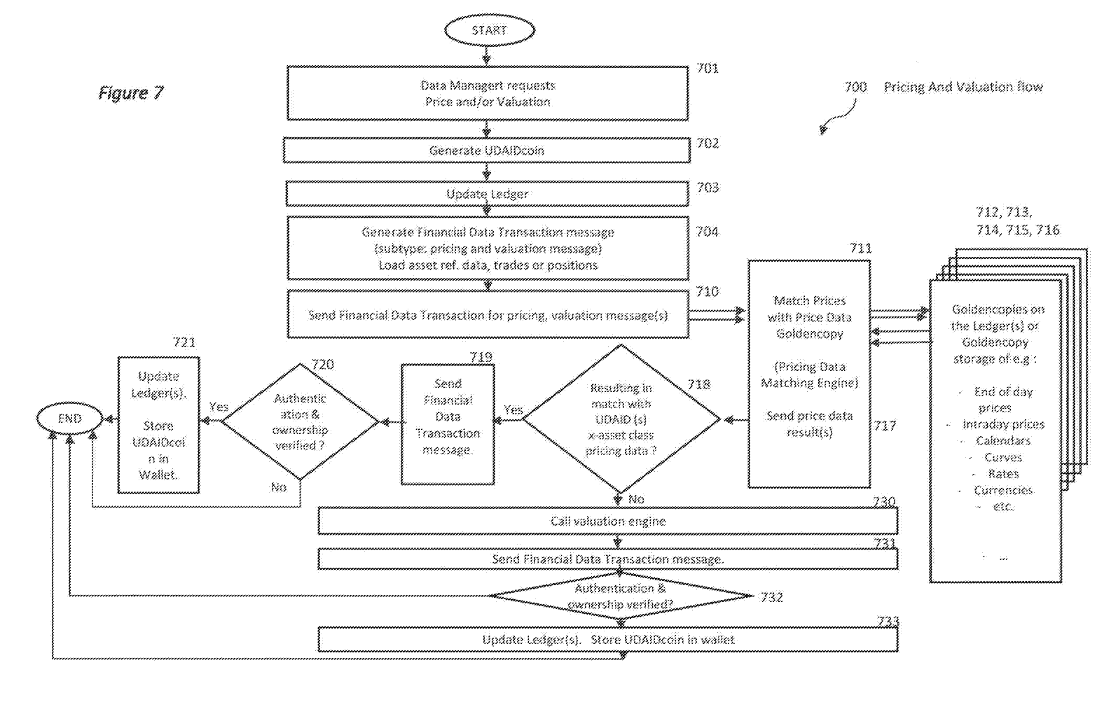

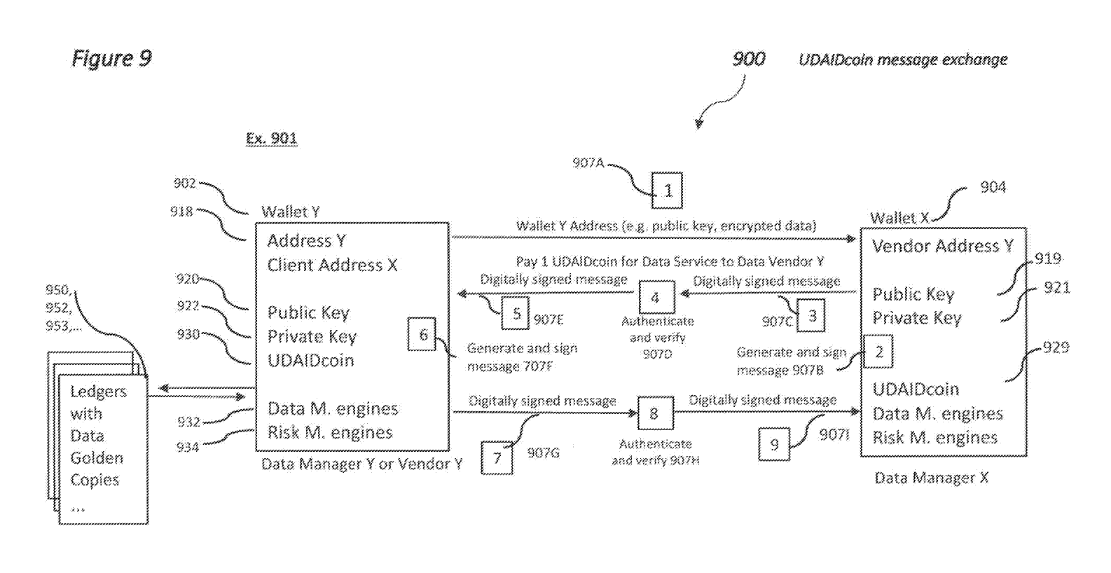

At step 619 respectively 623, it is assumed that UDAIDcoins have changed ownership from the data requester (Data Manager X) to Data Manager Y or Vendor Y. As explained in more detail for FIG. 7, the Data Managers' respective wallets 500w each generate respective Financial Data Transaction messages 303. For example, Data Manager's wallet 500w, here 904 generates a Financial Data Transaction message 303 that includes Data Managers Y's address 304, and past ownership information 312, if any, (i.e., a record of the previous exchange in between any Data Managers/Vendors). The Financial Data Transaction message 303 is digitally signed by Data Managers X private key to create digital signature 313, and the Financial Data Management and Financial Risk Management messages 302 is sent to the network. Similarly, Data Providers Y's wallet 500w, or 902 in FIG. 9 generates and sends a Financial Data Management and Financial Risk Management Data message 302 corresponding to his exchange of Asset Identification And Reference Data to Data Managers X wallet 500w, or 904 in FIG. 9.

Depending on the flow, either at step 618 or respectively step 622, each Data Manager's authenticity is verified based on each Data Manager's respective digital signature 313, and ownership rights are verified based on a proper chain of title (i.e., a history of previously established credible financial data transactions as determined by the ledger and/or other authoritative entity), as outlined above. Each Data Manager's ownership rights to the UDAIDcoin are verified by the network ledgers and, in some embodiments, ownership rights to data on the ledgers can also verified by the network ledgers. In one or more embodiments, the described technology is configured to store and verify other cryptographic currency (e.g., bitcoin) transactions in the same ledger as used to verify UDAIDcoins. In various embodiments, ledgers and/or other verification techniques used by other cryptographic currencies are referenced by the described technology for verifying the other cryptographic currency. In some embodiments, the described technology shares its ledgers and is configured to receive and/or adapt other cryptographic currencies' verification techniques for verifying cryptographic currency ownership. If, at step 618 or step 622, authentication and/or ownership cannot be verified, then, at step 618 or step 622, the transaction is ended. On the other hand, if authenticity and ownership are verified, then change of ownership is recorded, a record is entered into the ledgers and/or other cryptographic currency's verification technology and, at step 619 or step 623, UDAIDcoins and financial data are stored in each Data Manager's respective wallet 500w (e.g., the UDAIDcoins are stored in UDAIDcoin storage component 530 or 540. The process ends after execution at either after step 619 or after step 623.

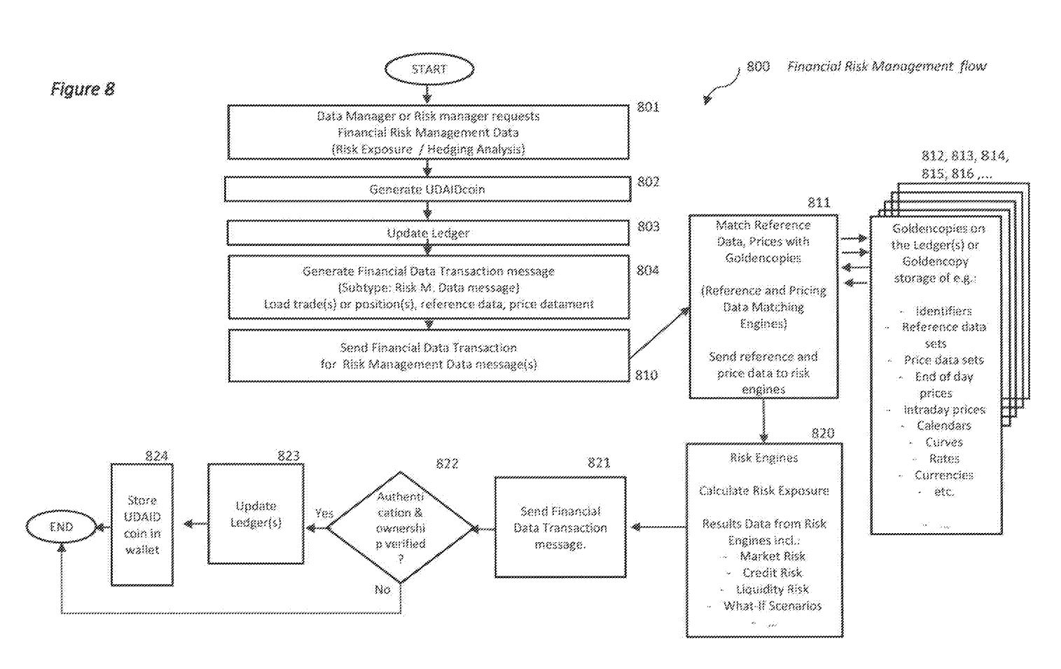

In different embodiments, the described technology is configured to support, in a similar technical way, as outlined above, the slightly different process flows for Price And Valuation Data—that is outlined beneath in FIG. 7 or the Financial Risk Management Data flow, which is outlined below in FIG. 8. Depending on the data management or financial risk management data requirements of the Data Manager, submessage types can be applied in various embodiments, that support slightly different flows to adapt better to the requirements of specific data sets and its management.

Reference to FIG. 7, in different embodiments, key differentiator for the Price And Valuation Data flow lies in that, in case of a negative match with the price data golden copies on the ledger, a valuation of the asset(s) is triggered in step 730.

Reference to FIG. 8, in different embodiments, the key differentiator for the Financial Risk Management Data flow lies in that, Risk Engines 545 are tasked in step 820 to execute the required risk exposure calculations for the respective asset(s), which include one or more market risk, credit risk, liquidity risk or e.g. what-if scenarios, hedges etc.

With each new successful exchange, ownership verification is improved based on a larger list of successful transactions as recorded in the network ledgers. Each UDAIDcoin verification increases the probability that the UDAIDcoin has a valid chain of title from its issuer to its current owner. Statistically, after a number of successful verifications, the likelihood that a previous verification is fraudulent decreases dramatically.

In one or more embodiments FIG. 9 is an UDAIDcoin communications flow diagram 900 that depicts a simplified example of UDAIDcoin message exchange. In example 901, Data Manager X's wallet 904 has one hundred UDAIDcoin 929, with a countervalue of “1” each, so 100 in total. Data Manager X intends to send one UDAIDcoin 929 from his wallet 904 to Data Manager Y's wallet 902 for the Financial Data Service e.g. subtype asset identification and financial data request for the asset Bitcoin Cash. At step 1 907A, Data Manager Y confirms his public address 918 (encrypted with public key 920) to Data Manager X's wallet 904, so Data Manager X has the address where to send UDAIDcoin 929 which incorporates the financial data request of Data Manager X to be executed by Data Manager resp. Data Vendor Y. At step 2 907B, Data Manager X's wallet 904 generates a Financial Data Management And Risk Management Data message 302 for sending UDAIDcoin 929 with the populated data request, digitally signs the financial data transaction 303 using the private key 921 associated UDAIDcoin 929 and, at step 3 907C, broadcasts a digitally signed financial data management and financial risk management data message 302 to the network 235. At step 4 907D, the network verifies that the financial data management and financial risk management data message 302 is authentic (i.e., it is from Data Manager X based on decrypting the digital signature 313 with public key 919) and that Data Manager has proper ownership (by verifying in the ledgers that Data Manager X is in the proper chain of title for UDAIDcoin 929). If step 4 907D is successful, the ledgers make an entry indicating that Data Manager Y is the new owner (based at least on Data Managers public key 920), and, at step 5 913, Data Manger Y's wallet 902 receives and stores the UDAIDcoin 929, which is secured with private key 922. Data Manager X's wallet 904 has ninety-nine UDAIDcoins 929 after this transaction.

Now, that the UDAIDcoin 929 has been received by Data Manager Y, Data Manager Y's wallet executes the data management tasks and returns a financial data reply populated UDAIDcoin 930 to Data Manager X. At step 6 907F, Data Manager X's wallet 902 generates a Financial Data Management And Risk Management Data message 302 for sending UDAIDcoin 930 with the populated data reply, digitally signs the financial data transaction 303 using the private key 922 associated UDAIDcoin 930 and, at step 7 907G, broadcasts a digitally signed financial data management and financial risk management data message 302 to the network 235. At step 8 907H, the network verifies that the financial data management and financial risk management data message 302 is authentic (i.e., it is from Data Manager Y based on decrypting the digital signature 313 with public key 919) and that Data Manager has proper ownership (by verifying in the ledgers that Data Manager Y is in the proper chain of title for UDAIDcoin 930). If step 8 907H is successful, the ledgers make an entry indicating that Data Manager X is the new owner (based at least on Data Managers public key 919), and, at step 9 907I, Data Manger X's wallet 904 receives and stores the UDAIDcoin 930, which is secured with private key 921. Data Manager X's wallet 904 has one hundred UDAIDcoins 929 after this transaction.

A Data Manager can use the same public address for multiple UDAIDcoin transactions; however, in one or more embodiments (not shown), new public-private key pairs are generated for each of several UDAIDcoin transactions. In some embodiments, an obligation protocol 1010 is used by the described technology for exchanging UDAIDcoin(s) between Data Managers. The Obligation Protocol 1010 is a distributed algorithm that helps ensure that each Data Manager is prepared to make and does make his/her part of the financial data transaction. There are at least two steps in the Obligation Protocol 1010 obligation request phase 1 and an obligation phase 2. During the obligation request phase, a coordinator (e.g., one or more nodes on the network 235) prepares some or all of the processes necessary to exchange an UDAIDcoin. During the execution phase, in some embodiments, when the necessary processes are verified each wallet broadcasts transaction messages.

In trade flow 1001, Data Manager Z is exchanging one UDAIDcoin 1044 for Data Manager Y's one UDAIDcoin 1030. During the obligation request phase, a coordinator (e.g., one or more nodes on the network 235) prepares one, multiple or all of the processes necessary to exchange the UDAIDcoin 1044 for the UDAIDcoin 1030. The described technology can prepare and coordinate both Data Managers wallets 1002 and 1040 to verify that each, have received and sent necessary keys 1020, 1022, 1042, 1043, have generated and exchanged public addresses 1018 and 1041, have generated proper financial data management and financial risk management data messages 302, and verified authenticity respectively ownership. In some embodiments, when the necessary processes are verified during the obligated phase, each wallet 1002 and 1040 broadcasts the financial data management and financial risk management data messages 302 to the network and the transactions are authenticated, verified. Via the obligation protocol 1010 processes, each Data Manager's financial data management and financial risk management data messages 302 are sent to and held in a queue managed by third party to the transaction, for example by one node 205-210 or a server 215. Each financial data management and financial risk management data message 302 is released by the third party after completion of the obligation phase.

In general, the detailed description of embodiments of the software and hardware facilities is not intended to be exhaustive or to limit the technology to the precise form disclosed above. While specific embodiments of, and examples for, the technology are described above for illustrative purposes, various equivalent modifications are possible within the scope of the software and/or hardware facilities, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. The teachings of the software and/or hardware facilities provided herein can be applied to other systems, not necessarily the system described herein. The elements and acts of the various embodiments described herein can be combined to provide further embodiments.

These and other changes can be made to the software and hardware facilities in light of the above Detailed Description. While the above description details certain embodiments of the technology and describes the best mode contemplated, no matter how detailed the above appears in text, the described technology can be practiced in many ways. The described technology may vary considerably in its implementation details, while still being encompassed by the technology disclosed herein. As noted above, particular terminology used when describing certain features or aspects of the described technology facilities should not be taken to imply that the terminology is being redefined herein to be restricted to any specific characteristics, features, or aspects of the technology with which that terminology is associated. In general, the terms used in the following claims should not be construed to limit the described technology facilities to the specific embodiments disclosed in the specification, unless the above Detailed Description section explicitly defines such terms. Accordingly, the actual scope of the described technology encompasses not only the disclosed embodiments, but also all equivalent ways of practicing or implementing the described technology.

To reduce the number of claims, certain aspects of the invention are outlined below in certain claim forms, but the applicant contemplates the various aspects of the invention in any number of claim forms. The applicant reserves the right to pursue additional claims after filing this application to pursue such additional claim forms, in either this application or in a continuing application.

1. A computer-readable storage device having contents adapted to cause a programmed computer system comprising of one or multiple processor(s), a data storage system, at least one input device, and at least one output system, to perform operations, the operations comprising:
generating a cryptographic currency, wherein the cryptographic currency is generated by an issuer of the cryptographic currency, and wherein the cryptographic currency includes financial data and financial risk management data items including unique digital asset identifier and reference data, price data, pricing and valuation data, financial risk management data; producing one or more electronic financial data transaction messages, for exchanging the cryptocurrency, wherein the one or more electronic financial data transaction messages at least include financial data transaction, of one or more asset identification and reference data, price data, pricing and valuation data, financial risk management data and a digital signature of the financial data transaction, wherein the financial data transaction at least includes:
a recipient electronic address for receiving the cryptographic currency; and
the cryptographic currency; and
executing an asset identification and reference data confirmation and/or unique digital asset identifier data generation request, and/or price data request, and/or pricing and valuation data request and/or financial risk management data request, wherein the financial data transaction of the cryptographic currency is based on sending, via computing nodes of a peer-to-peer network, the one or more electronic messages for delivery to the recipient address, wherein existence of the identifier(s), reference data, price data, and pricing data are verified based on one or more network ledgers within a one or more nodes of the peer-to-peer network.

2. The computer-readable storage device of claim 1 wherein the asset identification, reference and price data matching, pricing and valuation, and financial risk management is executed using a virtual wallet.

3. The computer-readable storage device of claim 1 wherein the asset identification, reference and price data matching, asset pricing and valuation, and financial risk management is executed using a virtual wallet, wherein multiple engines cooperate, including at least two engines including reference data matching engine, price data matching engine, pricing engine, valuation engine, risk engine, hedging engine, data aggregation engine.

4. The computer-readable storage device of claim 1 wherein the financial data management and financial risk management for a single asset managed in the wallet, all assets or a subset of the assets managed in the wallet is executed using a virtual wallet.

5. The computer-readable storage device of claim 1 wherein the financial risk management is executed using a virtual wallet, which contains multiple engines, including at least one risk engine, wherein risk exposures are computed, including one or more of market risk, credit risk, liquidity risk, hedges and what-if scenarios.

6. The computer-readable storage device of claim 1 wherein the verification is a verification of proper chain-of-title of the cryptocurrency.

7. The computer-readable storage device of claim 1 wherein the financial data and financial risk management data request(s) and result(s) delivery is based on public key cryptography.

8. A computer-implemented method, comprising:
determining a cryptographic currency, wherein the cryptographic currency includes a unique digital asset identifier and reference data, price data, pricing and valuations data, and financial risk management data; storing the cryptographic currency in a virtual wallet, wherein the virtual wallet is configured to store one or more types of cryptographic currencies and digital and cross-asset digitalized assets; and
exchanging, via a network, the cryptographic currency that includes the financial data and financial risk management data for cryptographic currency.

9. The computer-implemented method of claim 8 wherein the one or more other cryptographic currencies are of a same type of cryptographic currency as the determined cryptographic currency.

10. The computer-implemented method of claim 8 wherein one or more electronic Financial Data Management and Financial Risk Management Data messages are used for exchanging the cryptographic currency.

11. The computer-implemented method of claim 8 wherein one or more of the Financial Data Management and Financial Risk Management Data messages include a digital signature, address and the unique digital asset identifier and at least financial data and/or financial risk management data.

12. The computer-implemented method of claim 8 wherein ownership of the asset(s) and ownership of the one or more unique digital asset identifiers are based on at least one entry associated with one or more digital ledgers.

13. The computer-implemented method, comprising:
generate a cryptographic currency, wherein the cryptographic currency includes a unique digital asset identifier and reference and price data, pricing and valuation data, and financial risk management data; storing the cryptographic currency in a virtual wallet; and
matching the one or more items of the reference and price data based on one or multiple data sets with the reference “golden copy” data available on the ledger(s) for the specific data set(s), with the matching being executed based on one or more quantitative and/or qualitative rules.

14. The computer-implemented method of claim 13 wherein the asset identification matching method didn't provide a positive asset identification reference data reply, a new unique digital asset identifier request message is generated, executed and published to the ledger(s).

15. The computer-implemented method of claim 13 wherein the price matching method didn't provide a positive reply, an asset valuation request process/message is triggered and executed.

16. The computer-implemented method of claim 13 wherein the valuation of a single asset or all assets or subset of managed assets in the wallet is requested by the wallet user/Data Manager and executed.

17. The computer-implemented method of claim 13 wherein the financial risk management for a single or all assets or a subset of assets managed in the virtual wallet is requested and executed using a virtual wallet, wherein multiple engines cooperate, including at least a risk engine, wherein risk exposures and hedges are computed: including at least one or more of market risk, credit risk, liquidity risk, what-if scenarios, and hedges.

18. A peer-to-peer cryptographic currency financial data management and financial risk management method, comprising:
Initiating, via a computer, an exchange of one or more Financial Data Management and Financial Risk Management Data messages in a virtual wallet for a cryptocurrency;
determining, via a computer implemented two-phase obligation protocol, whether the virtual wallet manages the asset;
verifying, via the two-phase obligation protocol, that the virtual wallet has a cryptocurrency for exchange; and exchange financial data and financial risk management data for a cryptocurrency.

19. A peer-to-peer cryptographic currency financial data management and financial risk management method of claim 18, wherein the virtual wallet, comprising:
a cryptographic currency, wherein the cryptographic currency includes a unique digital asset identifier, financial reference and price data, pricing and valuation data, and financial risk management data;
one or more data management engines, data matching engines, data aggregation engines, pricing and valuation engines, and financial risk management engines (risk engines) for executing data management, data matching, data aggregation, reference and price data population, pricing and valuation, and financial risk management,
via a peer-to-peer network, of the cryptographic currency; and
cryptographic keys, wherein the cryptographic keys are for at least determining financial data messages for exchanging the cryptographic currency as part of the financial data management and financial risk management.
